(19) United States
(12) Patent Application Publication
(10) Pub. No.: US 2007/0159431 A1
(43) Pub. Date: Jul. 12, 2007

(54) LIQUID CRYSTAL DISPLAY DEVICE AND LIQUID CRYSTAL DRIVER

(75) Inventor: Koji SHIGEHIRO, Kumagaya-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Toshiba Matsushita Display Technology Co., Ltd., Tokyo (JP)

(21) Appl. No.: 11/610,613

(22) Filed: Dec. 14, 2006

(30) Foreign Application Priority Data
Jan. 10, 2006 (JP) 2006-002912

(51) Int. Cl. G09G 3/36

(52) U.S. Cl. 345/89

(57) ABSTRACT

In order to prevent the reproducibility of a display image from degrading due to the characteristic of a liquid crystal, a liquid crystal display device includes: a liquid crystal panel; a gray scale value generation unit which generates, based on a first gray scale value, a second gray scale value with a gray scale number smaller than the gray scale number of the first gray scale value; and a brightness control unit which sequentially controls the brightness of a corresponding liquid crystal pixel based on the second gray scale value generated by the gray scale value generation unit in a case where the first gray scale value is within a predetermined range, and which controls the brightness of the corresponding liquid crystal pixel based on the first gray scale value in a case where the first gray scale value is out of the predetermined range.

### CROSS-REFERENCE TO RELATED APPLICATIONS

This application is based upon and claims the benefit of priority from Japanese Patent Application No. 2006-2912 filed Jan. 10, 2006; the entire contents of which are incorporated herein by reference.

### BACKGROUND OF THE INVENTION

1. Field of the Invention

The present invention relates to a liquid crystal display device and a liquid crystal driver, which prevent the reproducibility of a display image from degrading due to a characteristic of a liquid crystal.

2. Description of the Related Art

Liquid crystal display devices in recent years have been used for various apparatuses, such as a television receiver, a display device of a computer, and a cellular phone terminal.

Techniques for controlling the brightness of each liquid crystal pixel of the liquid crystal display device includes Frame Rate Control, a combination of Frame Rate Control and dithering, and the like.

Now, as for a characteristic of a liquid crystal, in a range of lower applied voltage and in a range of higher applied voltage, the brightness varies nonlinearly relative to a change in the applied voltage, while in the region therebetween the brightness varies linearly relative to the applied voltage.

For this reason, in the case where Frame Rate Control or dithering is employed, the reproducibility of a display image degrades in a range of lower gray scale values and in a range of higher gray scale values. In order to avoid the degradation of the reproducibility of a display image, an 8-bit gray scale value may be used as it is without employing Frame Rate Control or dithering. Since in the range where the brightness varies linearly relative to the applied voltage, however, the rate of change of the brightness relative to the applied voltage is large, high accuracy is required for the digital to analog conversion of the 8-bit gray scale value, resulting in an increase in the circuit size.

### SUMMARY OF THE INTENTION

An object of the present invention is to provide a liquid crystal display device and a liquid crystal driver, which prevent the reproducibility of a display image from degrading due to a characteristic of a liquid crystal, without carrying out a highly accurate digital to analog conversion.

A liquid crystal display device according to a first aspect of the invention, includes: a liquid crystal panel in which a plurality of liquid crystal pixels are arranged; a gray scale value generation unit which generates, based on a first gray scale value for determining the brightness of a liquid crystal pixel, at least one second gray scale value with a gray scale number smaller than the gray scale number of the first gray scale value; and a brightness control unit which sequentially controls the brightness of a liquid crystal pixel corresponding to the first gray scale value based on the second gray scale value generated by the gray scale value generation unit in a case where the first gray scale value is larger than a lower threshold value and smaller than an upper threshold value, and which controls the brightness of the liquid crystal pixel corresponding to the first gray scale value based on the first gray scale value in a case where the first gray scale value is not larger than the lower threshold value or is not smaller than the upper threshold value.

A liquid crystal display device according to a second aspect of the invention, includes: a liquid crystal panel in which a plurality of liquid crystal pixels are arranged; a gray scale value generation unit which generates, based on a first gray scale value for determining the brightness of each of the plurality of liquid crystal pixels, a plurality of second gray scale values with a gray scale number smaller than the gray scale number of the first gray scale value; and a brightness control unit which sequentially controls the brightness of a plurality of liquid crystal pixels corresponding to the first gray scale value based on the plurality of second gray scale values generated by the gray scale value generation unit, in a case where the first gray scale value is larger than a lower threshold value and smaller than an upper threshold value, and which controls the brightness of the plurality of liquid crystal pixels corresponding to the first gray scale value based on the first gray scale value in a case where the first gray scale value is not larger than the lower threshold value or is not smaller than the upper threshold value.

A liquid crystal driver according to a third aspect of the invention, includes: a gray scale value generation unit which generates, based on a first gray scale value for determining the brightness of a liquid crystal pixel arranged in a liquid crystal panel, at least one second gray scale value with a gray scale number smaller than the gray scale number of the first gray scale value; and a brightness control unit which sequentially controls the brightness of a liquid crystal pixel corresponding to the first gray scale value based on the second gray scale value generated by the gray scale value generation unit, in a case where the first gray scale value is larger than a lower threshold value and smaller than an upper threshold value, and which controls the brightness of the liquid crystal pixel corresponding to the first gray scale value based on the first gray scale value in a case where the first gray scale value is not larger than the lower threshold value or is not smaller than larger the upper threshold value.

A liquid crystal driver according to a fourth aspect of the invention, includes: a gray scale value generation unit which generates, based on a first gray scale value for determining the brightness of a plurality of liquid crystal pixels arranged in a liquid crystal panel, a plurality of second gray scale values with a gray scale number smaller than the gray scale number of the first gray scale value; and a brightness control unit which sequentially controls the brightness of a plurality of liquid crystal pixels corresponding to the first gray scale value based on the plurality of second gray scale values generated by the gray scale value in a case where the first gray scale value is larger than a lower threshold value and smaller than an upper threshold value and which controls the brightness of the plurality of liquid crystal pixels corresponding to the first gray scale value based on the first gray scale value, in a case where the first gray scale value is not larger than the lower threshold value or is not smaller than the upper threshold value.

### BRIEF DESCRIPTION OF THE DRAWINGS

FIG. 1 is a diagram showing a schematic configuration of a liquid crystal display device according to an embodiment of the present invention.

FIG. 2 is a diagram showing a relationship between a voltage applied to a liquid crystal, and the brightness.

FIG. 3 shows correspondences between 8-bit gray scale values D and gray scale values in 65 gray scales.

FIG. 4 is a diagram explaining operations by Frame Rate Control.

FIG. 5 is a diagram for the purpose of explaining a method of controlling the brightness.

FIGS. 6A, 613, 6C, and 6D are diagrams showing gray scale values for each frame in ¼ FRC.

FIGS. 7A, 7B, 7C, and 7D are diagrams showing gray scale values obtained for each frame in a case where “0” is added to all the gray scale values d0.

FIGS. 8A, 8B, 8C, and 8D are diagrams showing gray scale values for each frame in 2/4 FRC.

FIGS. 9A, 9B, 9C, and 9D are diagrams showing gray scale values for each frame in ¾ FRC.

FIG. 10 is a diagram showing the difference between the brightness obtained in a case where the applied voltage is controlled corresponding to the 8-bit gray scale value D, and the brightness obtained in the case where the applied voltage is controlled corresponding to the gray scale value in 65 gray scales.

### DESCRIPTION OF THE EMBODIMENT

### First Embodiment

Hereinafter, embodiments of the present invention will be described with reference to the accompanying drawings.

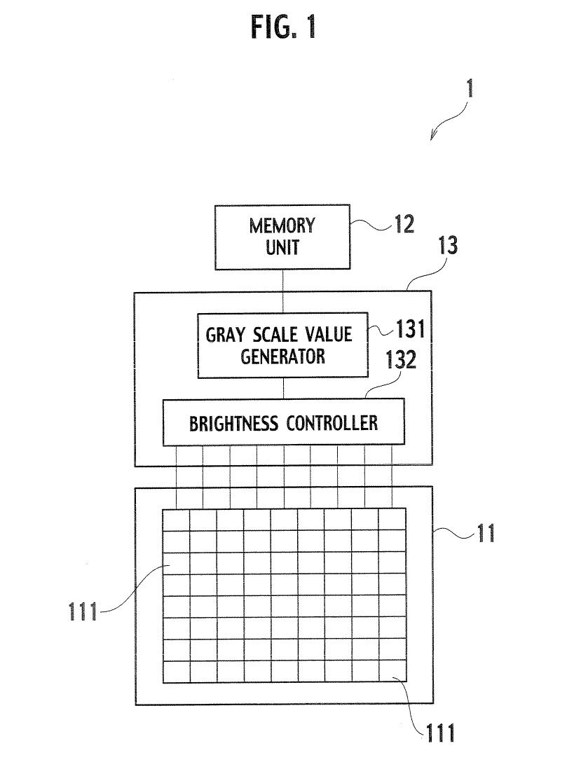

FIG. 1 is a diagram schematically showing the configuration of a liquid crystal display device 1 according to a first embodiment of the present invention.

The liquid crystal display device 1 of FIG. 1 is an active matrix type liquid crystal display device and includes a liquid crystal panel 11, a memory unit 12, and a liquid crystal driver 13. In the liquid crystal panel 11, liquid crystal pixels 111 using a liquid crystal are arranged in a matrix. An assumption is made that in the memory unit 12, image data including an 8-bit gray scale value D corresponding to each of the liquid crystal pixel 111 is stored. The gray scale value D is capable of representing 256 gray scales.

The liquid crystal driver 13 controls the brightness of each of the liquid crystal pixels 111. The liquid crystal driver 13 includes a gray scale value generator 131 and a brightness controller 132. The gray scale value generator 131 generates gray scale values in 65 gray scales from the gray scale value D of the image data stored in the memory unit 12. The brightness controller 132 controls the brightness of the liquid crystal pixels 111 based on the gray scale value in 65 gray scales, or on the gray scale value D.

In addition, the gray scale value generator 131 corresponds to a gray scale value generation unit, and the brightness controller 132 corresponds to a brightness control unit. The gray scale value D corresponds to a first gray scale value, and the gray scale value in 65 gray scales corresponds to a second gray scale value.

Next, the characteristic of a liquid crystal is described.

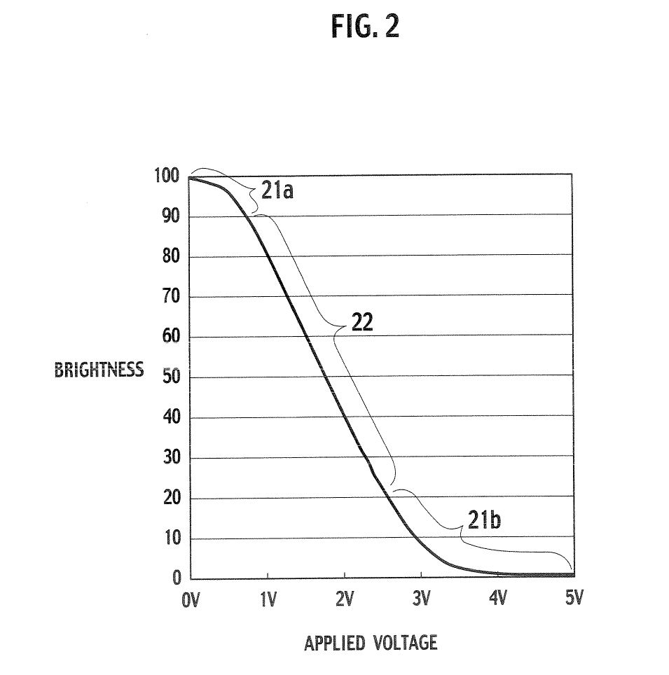

FIG. 2 is a diagram showing an example of a relationship between the applied voltage to a liquid crystal and the brightness, in a case of “normally white.” Here, the applied voltage and the brightness on a percentage basis are shown.

As shown in the diagram, in a range of lower applied voltage 21a and in a range of higher applied voltage 21b, the brightness varies nonlinearly relative to the applied voltage. That is, the variation in brightness is small with respect to the applied voltage. On the other hand, in a range 22 other than in the ranges of the lower applied voltage and higher applied voltage, the brightness varies linearly relative to the applied voltage.

In the liquid crystal display device of this embodiment, a fact that the brightness varies nonlinearly relative to the applied voltage in the range of lower applied voltage 21a and in the range of higher applied voltage 21b is taken into consideration.

Next, a process through which the liquid crystal display device 1 controls the brightness of the liquid crystal pixels 111 is described.

First, the brightness controller 132 of the liquid crystal display device 1 determines whether or not each of the gray scale values D of the image data stored in the memory unit 12 is larger than a lower threshold value and smaller than an upper threshold value. An assumption is made that the lower threshold value and upper threshold value are determined in advance.

For example, assume that the brightness controller 132 stores the lower threshold value “12” and the upper threshold value “244” in advance. Then, the brightness controller 132 determines whether or not each of the gray scale values D is larger than “12” and smaller than “244.”

As for the gray scale value D in the range larger than the lower threshold value and smaller than the upper threshold value, the gray scale value generator 131 generates gray scale values d1-d4 or d0′ in 65 gray scales, from the gray scale value D using Frame Rate Control.

That is, the gray scale value generator 131 drops the lower 2 bits of the gray scale value D, and adds one bit of a value “0” to the higher side thereof and thereby generates the gray scale value d0 in 64 gray scales. Then, the gray scale value generator 131 adds “1” or “0” to the least significant bit of the generated gray scale value d0 in 64 gray scales, and thereby generates the gray scale values d1-d4 or d0′ in 65 gray scales.

The generated gray scale values in 65 gray scales determine an applied voltage to a liquid crystal of the liquid crystal pixel 111 corresponding to the gray scale value D. The gray scale value d1 determines an applied voltage in a first frame of the liquid crystal pixel 111. The gray scale value d2 determines an applied voltage in a second frame of the liquid crystal pixel 111. The gray scale value d3 determines an applied voltage in a third frame of the liquid crystal pixel 111. The gray scale value d4 determines an applied voltage in a fourth frame of the liquid crystal pixel 111. The gray scale value d0′ determines an applied voltage from the first frame through the fourth frame of the liquid crystal pixel 111.

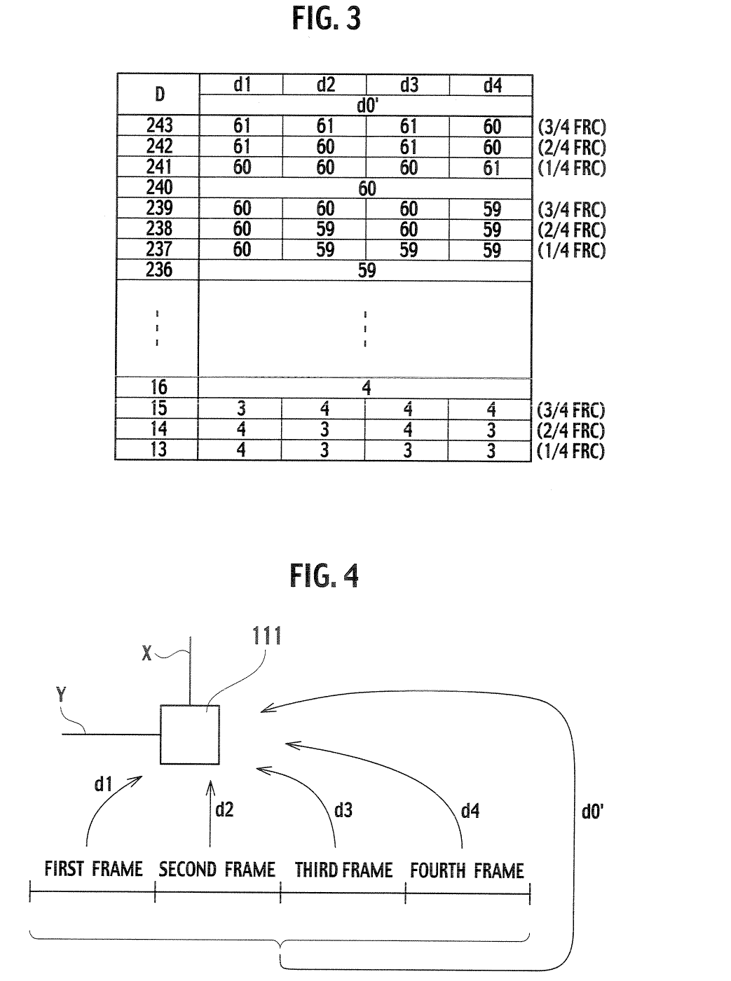

FIG. 3 is a conversion table between the gray scale value D in 256 gray scales, and the gray scale value in 65 gray scales.

For example, in a case where the gray scale value D is “240,” the gray scale value generator 131 generates the gray scale value d0′ of “60.” Accordingly, the brightness controller 132 controls the brightness of the liquid crystal pixel 111 corresponding to the gray scale value D to be a brightness corresponding to the gray scale value d0′ of “60,” throughout each frame.

In a case where the gray scale value D is “241,” the gray scale value generator 131 generates the gray scale values d1-d4 in ¼ FRC (Frame Rate Control). That is, the gray scale value generator 131 adds “1” to the gray scale value d0 for one of the gray scale values d1-d4, and adds “0” to the gray scale value d0 for the rest. In the illustrated example, the gray scale value generator 131 generates “d1: 60,” “d2: 60,” “d3: 60,” and “d4: 61.”

In a case where the gray scale value D is “242,” the gray scale value generator 131 generates the gray scale values d1-d4 of 2/4 FRC. That is, the gray scale value generator 131 adds “1” to the gray scale value d0 for two of the gray scale values d1-d4, and adds “0” to the gray scale value d0 for the rest.

In a case where the gray scale value D is “243,” the gray scale value generator 131 generates the gray scale values d1-d4 of ¾ FRC. That is, the gray scale value generator 131 adds “1” to the gray scale value d0 for three of the gray scale values d1-d4, and adds “0” to the gray scale value d0 for the rest.

Accordingly, the brightness controller 132 controls the brightness of the liquid crystal pixel 111 corresponding to the gray scale value D to a brightness corresponding to the gray scale values d1-d4 for each frame.

FIG. 4 is an explanatory drawing of an operation in controlling the brightness of the liquid crystal pixel 111 corresponding to the generated gray scale values d1-d4, or d0′.

In the case where the gray scale values d1-d4 are generated, in a first frame the brightness controller 132 digital-to-analog converts the gray scale value d1 into voltage. Then, the brightness controller 132 provides the converted voltage to a signal line X corresponding to the liquid crystal pixel 111 during a horizontal scanning period in which a scanning line Y corresponding to the liquid crystal pixel 111 is driven. Accordingly, the brightness controller 132 controls, via a transistor (not shown) which is conducted by the drive of the scanning line Y, the voltage of a pixel electrode (not shown) of the liquid crystal pixel 111, and thereby sets the brightness of the liquid crystal pixel 111 to the one corresponding to the gray scale value d1.

In a subsequent second frame, the brightness controller 132 sets the brightness of the liquid crystal pixel 111 to the one corresponding to the gray scale value d2, in the same manner used in the first frame. In a subsequent third frame, the brightness controller 132 sets the brightness of the liquid crystal pixel 111 to the one corresponding to the gray scale value d3, in the same manner used in the first frame. In a subsequent fourth frame, the brightness controller 132 sets brightness of liquid crystal pixel 111 to the one corresponding to the gray scale value d4, in the same manner used in the first frame.

In the case where the gray scale value d0′ is generated, the brightness controller 132 sets the brightness of the liquid crystal pixel 111 to the one corresponding to the gray scale value d0′ through each frame, in a similar manner.

By using the Frame Rate Control described above, the brightness in a total of four frames becomes one corresponding to the gray scale value D.

On the other hand, in the case where the gray scale value D is not larger than the lower threshold value or is not smaller than the upper threshold value, the brightness controller 132 controls the brightness of the liquid crystal pixel 111 corresponding to the gray scale value D in the following manner.

In addition, the range in which the gray scale value D is not larger than the lower threshold value and the range in which the gray scale value D is not smaller than the upper threshold value are the ranges of the gray scale value when the applied voltage corresponding to the gray scale value D, the gray scale value D being included in these ranges, are included in the two ranges 21a and 21b of nonlinear applied voltage (see FIG. 2).

That is, in the case where the brightness is decreased as the gray scale value increases in a normally-white liquid crystal display device, the range of the gray scale value D, the gray scale value D being not larger than the lower threshold value, is the range of the gray scale value when the applied voltage corresponding to the gray scale value D is included in the range 21a of nonlinear applied voltage at the lower applied voltage side.

The range of the gray scale value not smaller than the upper threshold value is the range of the gray scale value when the applied voltage corresponding to the gray scale value D is included in the range 21b of nonlinear applied voltage at the higher applied voltage side.

First, the brightness controller 132 digital-to-analog converts the gray scale value D into voltage. Then, the brightness controller 132 provides the converted voltage to the signal line X corresponding to the liquid crystal pixel 111 during the horizontal scanning period in which the scanning line Y corresponding to the liquid crystal pixel 111 is driven throughout each frame. Accordingly, the brightness controller 132 controls, via a transistor (not shown) which is conducted by the drive of the scanning line Y, the voltage of a pixel electrode of the liquid crystal pixel 111, and thereby sets the brightness of the liquid crystal pixel 111 to the one corresponding to the gray scale value D.

In addition, the brightness controller 132 carries out a digital to analog conversion so that the voltage converted from the gray scale value D of “255” and the voltage converted from the gray scale value of “64” in 65 gray scales can become equal, for example.

FIG. 5 is an explanatory drawing for the purpose of explaining the control of brightness in this embodiment.

The illustrated table shows the gray scale value D, and gray scale values to be controlled based on this gray scale value D.

As described above, in the case where the gray scale value D is not larger than the lower threshold value (for example, “12”) or is not smaller the upper threshold value (for example, “244”), the value of the gray scale value D and the value in the control field are equal. In this case, the brightness of the liquid crystal pixel 111 corresponding to the gray scale value D is controlled to the brightness corresponding to the gray scale value D throughout each frame.

Moreover, it is also shown that in the case where the gray scale value D is larger than the lower threshold value and smaller than the upper threshold value, the brightness of the liquid crystal pixel 111 is controlled by Frame Rate Control.

In the first embodiment, the display as a still picture is performed by carrying out the processes described above. Moreover, the display as a moving picture is performed by carrying out the processes described above sequentially to a plurality of image data.

In the first embodiment, the 8-bit digital to analog conversion is carried out only in the case where the gray scale value D is not larger than the lower threshold value or in the case where it is not smaller than the upper threshold value. In this range, high conversion accuracy is not required because the rate of change in brightness is small, as shown in FIG. 2. Thus, in the first embodiment, a large-scale digital to analog conversion circuit is not necessary.

In the first embodiment, in the case where the gray scale value D is not larger than the lower threshold value or in the case where it is not smaller than the upper threshold value, the brightness of a liquid crystal pixel is controlled to be brightness corresponding to the gray scale value D. Accordingly, in the range where the gray scale value D is not larger than the lower threshold value or in the range where the gray scale value D is not smaller than the upper threshold value, the reproducibility of a display image can be prevented from degrading due to the characteristic of a liquid crystal in which the brightness varies nonlinearly.

In addition, in the Frame Rate Control of the first embodiment, four gray scale values in 65 gray scales are generated from the gray scale value D and the number of times of the brightness control is set to be four. The number of the gray scale values to be generated and the number of times of brightness control may be changed and implemented, however.

### Second Embodiment

Next, a second embodiment is described.

A liquid crystal display device of a second embodiment differs from the liquid crystal display device of the first embodiment (see FIG. 1) only in the following points. That is, the brightness controller 132 of the second embodiment uses a dithering method (dither technique) in which the brightness of a plurality of liquid crystal pixels 111 is controlled with one gray scale value D.

Moreover, an assumption is made that in the memory unit 12 of the second embodiment, image data including the 8-bit gray scale value D is stored for each 16 liquid crystal pixels 111, a total of 16 liquid crystal pixels forming a block.

Next, a process through which the liquid crystal display device 1 of this embodiment controls the brightness of the liquid crystal pixel 111 is described.

First, the brightness controller 132 determines whether or not each of gray scale values D of the image data stored in the memory unit 12 is larger than a lower threshold value and smaller than a higher threshold value, in the same way as that of the first embodiment. In addition, an assumption is made that the lower threshold value and the higher threshold value are determined in advance based on the characteristic of the liquid crystal shown in FIG. 2 like in the first embodiment.

As for the gray scale value D in the range larger than the lower threshold value and smaller than the higher threshold value, the brightness of the liquid crystal pixel 111 is controlled combining Frame Rate Control with the dithering method.

The gray scale value generator 131 generates 64 gray scale values (16×4 frames) in 65 gray scales based on the gray scale value D.

That is, the gray scale value generator 131 drops the lower 2 bits of the gray scale value D and adds one bit of a value “0” to the higher side thereof and thereby generates the gray scale value d0 in 64 gray scales. Then, the gray scale value generator 131 adds “1” or “0” to the least significant bit of the generated gray scale value d0 in 64 gray scales and thereby generates the gray scale values in 64 gray scales.

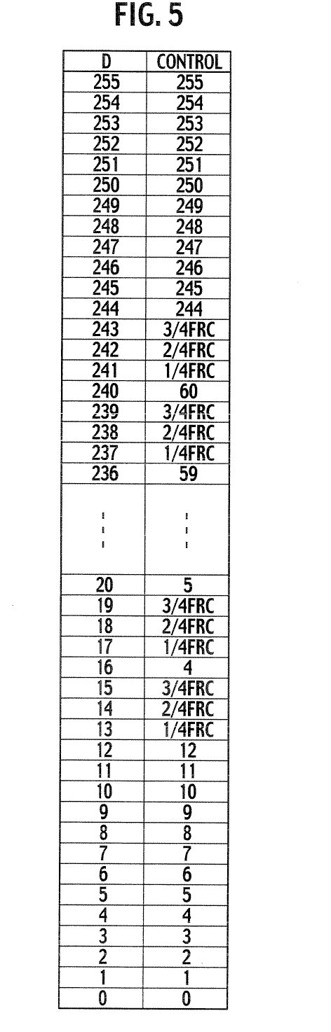

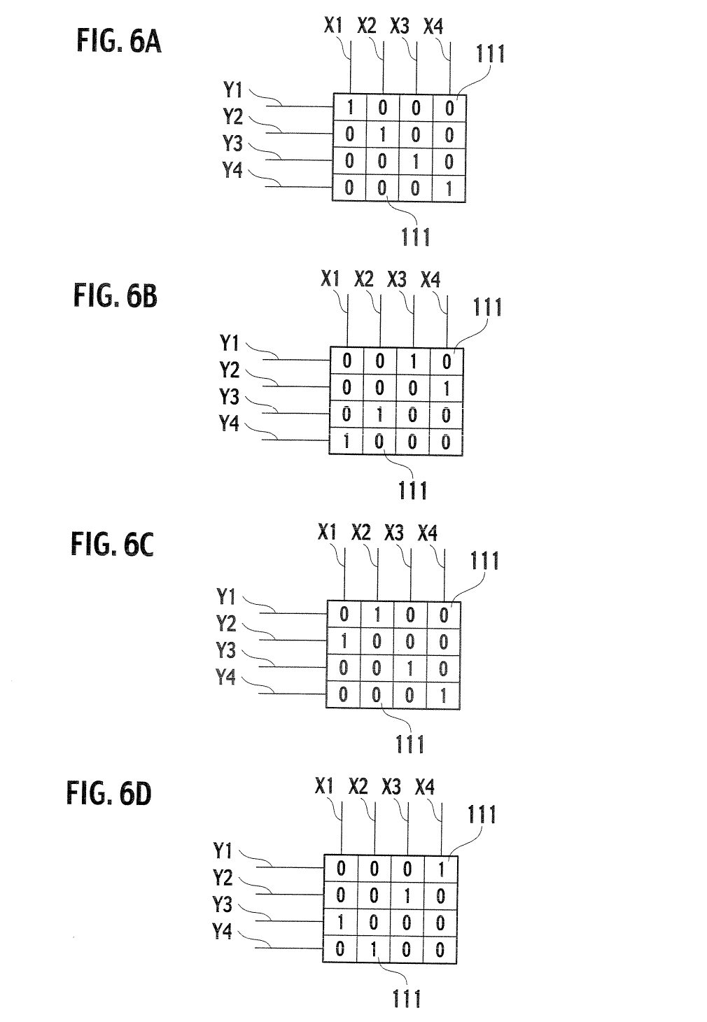

FIGS. 6A, 6B, 6C, and 6D show the gray scale values in the case where for 4 gray scale values, “1” is added to the gray scale value d0, and for the remaining 12 gray scale values, “0” is added to the gray scale value d0. In the illustrated example, a liquid crystal pixel corresponding to the gray scale value to which “1” is added is designated by “1,” and a liquid crystal pixel corresponding to the gray scale value to which “0” is added is designated by “0”.

FIG. 6A shows the gray scale values in a first frame, FIG. 6B shows the gray scale values in a second frame, FIG. 6C shows the gray scale values in a third frame, and FIG. 6D shows the gray scale values in a fourth frame.

As shown in FIGS. 6A to FIG. 6D, 16 gray scale values generated for each frame determines the applied voltage in each frame with respect to each liquid crystal of 16 liquid crystal pixels 111, the 16 liquid crystal pixels forming a block.

The brightness controller 132 digital-to-analog converts the gray scale value in 65 gray scales corresponding to each of the liquid crystal pixels 111 shown in FIG. 6A, in the first frame. Then, the brightness controller 132 provides the converted voltage to a signal line corresponding to the liquid crystal pixel 111 during the horizontal scanning period in which the scanning line Y corresponding to the liquid crystal pixel 111 is driven. Accordingly, the brightness of each of the liquid crystal pixels 111 is controlled to the one corresponding to the gray scale value in 65 gray scales.

In the subsequent second frame, the brightness controller 132 controls the brightness of 16 liquid crystal pixels 111 to the one corresponding to each of the gray scale values shown in FIG. 6B.

In the subsequent third frame, the brightness controller 132 controls the brightness of 16 liquid crystal pixels 111 to the one corresponding to each of the gray scale values shown in FIG. 6C.

In the subsequent fourth frame, the brightness controller 132 controls the brightness of 16 liquid crystal pixels 111 to the one corresponding to each of the gray scale values shown in FIG. 6D.

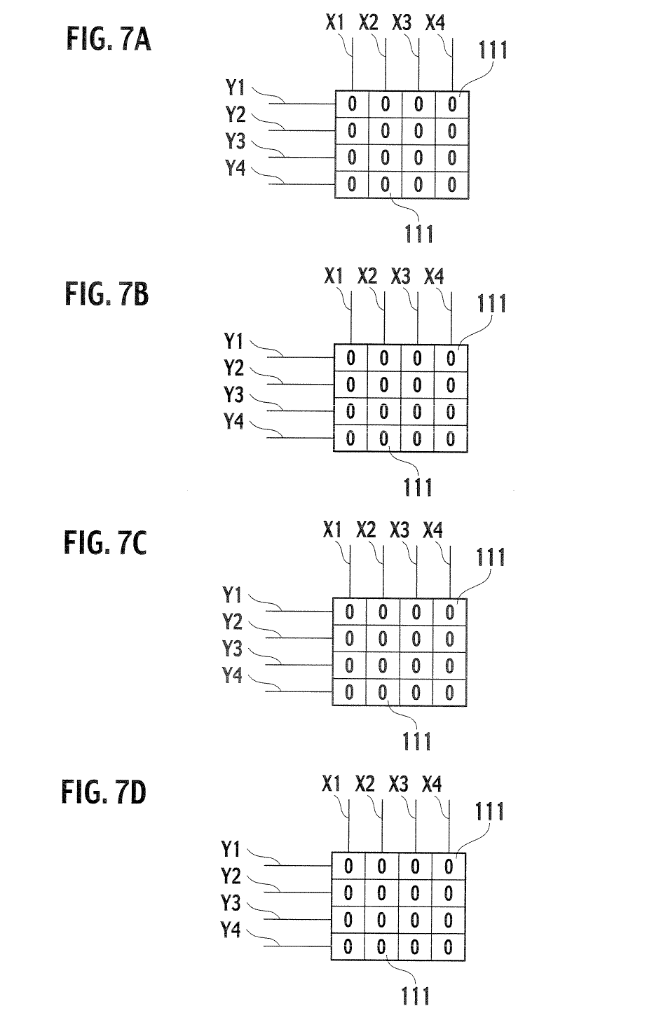

FIG. 7A shows the case where “0” is added to the gray scale value d0 for all the gray scale values in the first frame. In this case, as shown in FIGS. 7B, 7C, and 7D, “0” is also added to the gray scale value d0 for all the gray scale values in the second frame, third frame, and fourth frame.

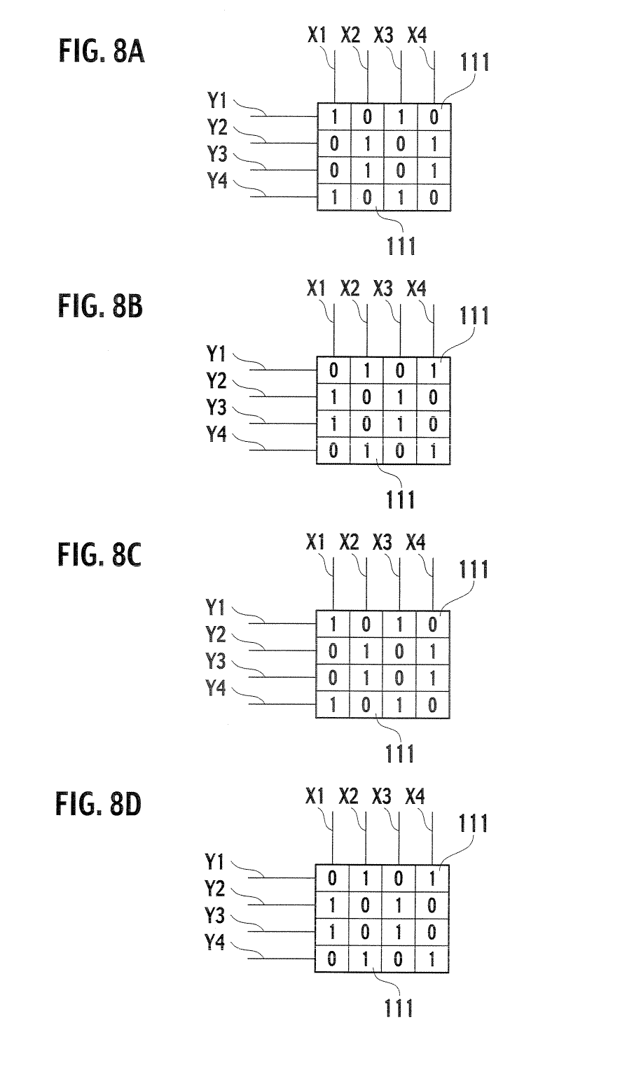

FIG. 8A shows the case where among the gray scale values in the first frame, for 8 gray scale values, “1” is added to the gray scale value d0, and for the remaining 8 gray scale values “0” is added to the gray scale value d0. In this case, the gray scale values in the second frame, third frame, and fourth frame are the ones shown in FIGS. 8B, 8C, and SD.

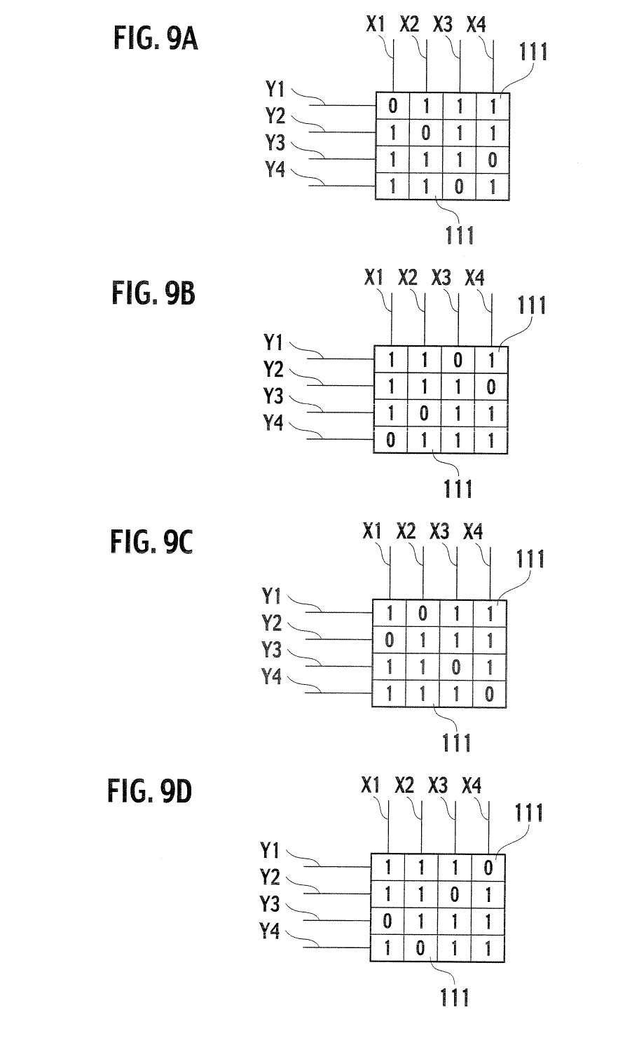

FIG. 9A shows the case where among the gray scale values in the first frame, for 12 gray scale values, “1” is added to the gray scale value d0, and for the remaining 4 gray scale values “0” is added to the gray scale value do. In this case, the gray scale values in the second frame, third frame, and fourth frame are the ones shown in FIGS. 9B, 9C, and 9D.

By using the Frame Rate Control described above, the brightness in a total of four frames becomes one corresponding to the gray scale value D.

The flickering of display can be reduced by combining the dithering method, in which the brightness of a plurality of liquid crystal pixels 111 is controlled with one gray scale value D, with the Frame Rate Control.

On the other hand, in the case where the gray scale value D is not larger than the lower threshold value or is not smaller than the upper threshold value, the brightness controller 132 digital-to-analog converts the gray scale value D into voltage. Then, the brightness controller 132 provides the converted voltage to the signal line X corresponding to the liquid crystal pixel 111 during the horizontal scanning period in which the scanning line Y corresponding to the liquid crystal pixel 111 is driven, throughout each frame. Accordingly, the brightness controller 132 controls, via a transistor which is conducted by the drive of the scanning line, the voltage of a pixel electrode of each of the liquid crystal pixels 111, and thereby sets the brightness of each of the liquid crystal pixels 111 to the one corresponding to the gray scale value D.

FIG. 5, which has been referred to in the first embodiment, also shows the control of brightness in the second embodiment.

That is, in FIG. 5, also in the second embodiment, in the case where the gray scale value D is not smaller than “244” or is not larger than “12,” the same value as the value of the gray scale value D is set in the control field. This indicates that the brightness of the liquid crystal pixel 111 is controlled to be the brightness corresponding to the gray scale value D throughout each frame.

In FIG. 5, for a certain gray scale value D (for example, “240”), the corresponding gray scale value (for example, “60”) in 65 gray scales is set in the control field. This indicates that, as shown in FIGS. 7A to 7D, for all the gray scale values in 65 gray scales generated from the gray scale value D, “0” is added to the gray scale value d0.

In FIG. 5, for a certain gray scale value D (for example, “241”), ¼ FRC is set in the control field. This indicates that, as shown in FIG. 6A to FIG. 6D, for ¼ of the gray scale values in 65 gray scales generated from the gray scale value D, “1” is added to the gray scale value d0.

In FIG. 5, for a certain gray scale value D (for example, “242”), 2/4 FRC is set in the control field. This indicates that, as shown in FIGS. 8A to 8D, for 2/4 of the gray scale values in 65 gray scales generated from the gray scale value D, “1” is added to the gray scale value d0.

In FIG. 5, for a certain gray scale value D (for example, “243”), ¾ FRC is set in the control field. This indicates that, as shown in FIGS. 9A to 9D, for ¾ of the gray scale values in 65 gray scales generated from the gray scale value D, “1” is added to the gray scale value d0.

In the second embodiment, by carrying out the processes described above, the display as a still picture is performed. Moreover, by sequentially carrying out the processes described above to a plurality of image data, the display as a moving picture is performed.

In the second embodiment, the 8-bit digital to analog conversion is carried out only in the case where the gray scale value D is not larger than the lower threshold value or it is not smaller than the upper threshold value. In this range, high conversion accuracy is not required because the rate of change of the brightness is small, as shown in FIG. 2. In the second embodiment, thus, a large-scale digital to analog conversion circuit is not necessary.

In the second embodiment, in the case where the gray scale value D is not larger than the lower threshold value or in the case where it is not smaller than the upper threshold value, the brightness of a liquid crystal pixel is controlled to be the brightness corresponding to the gray scale value D. Accordingly, in the range where the gray scale value D is not larger than the lower threshold value or in the range where the gray scale value D is not smaller than the upper threshold value, the reproducibility of a display image can be prevented from degrading due to the characteristic of the liquid crystal that the brightness varies nonlinearly.

In addition, in the second embodiment, 64 gray scale values in 65 gray scales are generated from the gray scale value D, and the number of times of brightness control is set to four. The number of gray scale values to generate and the number of times of brightness control may be changed and implemented, however.

For example, the number of the gray scale values to be generated may be a multiple number, and the number of times of brightness control may be set to one. That is, the brightness control may be carried out only by the dithering method.

In the first and second embodiments, whether or not the gray scale value D is within a predetermined range by using the predetermined lower threshold value and upper threshold value is determined. A table like the one shown in FIG. 5, however, may be stored in the liquid crystal display device and whether or not the gray scale value D is within a predetermined range may be determined referring to this table.

In the first and second embodiments, the cases are described in which the brightness is decreased as the gray scale value is increased in the normally-white liquid crystal display device, as an example. However, the present technique may be applied to the control in which the brightness is increased as the gray scale value is increased in a normally-black liquid crystal display device.

Although the liquid crystal driver and the liquid crystal panel are separated in the first and second embodiments, the liquid crystal driver may be integrally formed with the liquid crystal panel.

Although a display color has not been referred to in the first and second embodiments, the present technique may be employed in any one of monochrome and color liquid crystal display devices.

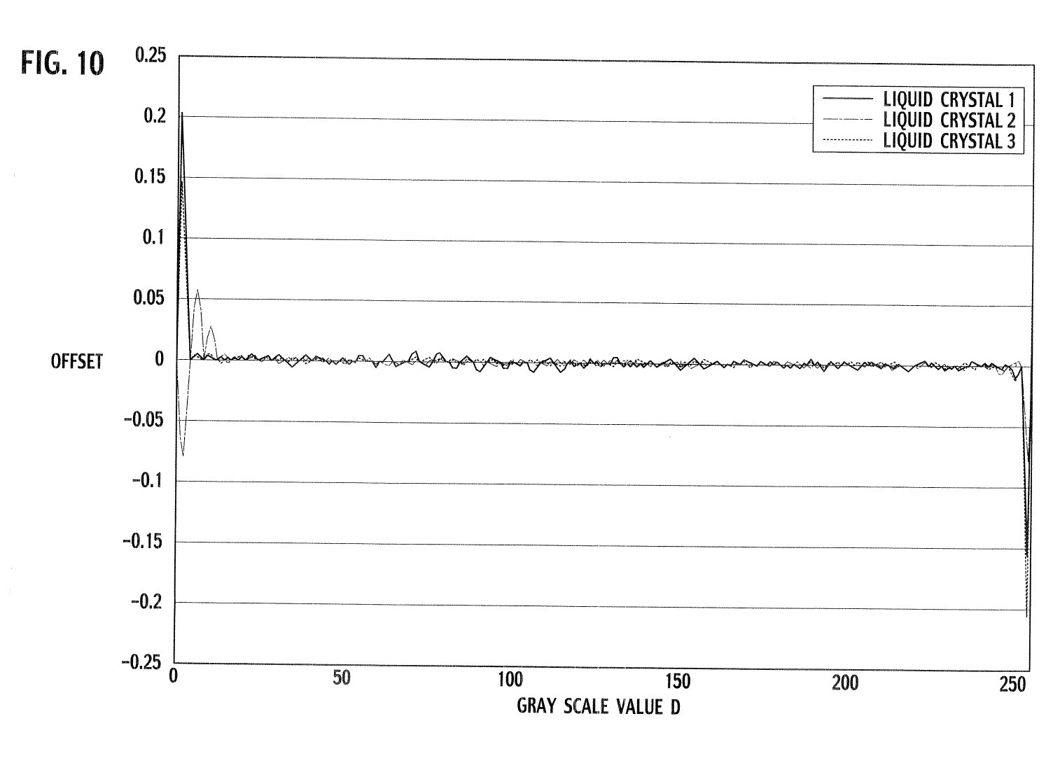

In addition, FIG. 10 is a diagram showing an offset, which is the difference between the brightness in the case where the applied voltage is controlled corresponding to the 8-bit gray scale value D, and the brightness in the case where the applied voltage is controlled corresponding to the gray scale value in 65 gray scales. The horizontal axis of FIG. 10 represents the gray scale value D, and the vertical axis represents the offset described above. Due to the characteristic of the liquid crystal shown in FIG. 2, in the range of lower gray scale values and in the range of higher gray scale values, the absolute value of the offset is large, and in the range therebetween the absolute value of the offset is small. That is, in the range of lower gray scale values and in the range of higher gray scale values, the reproducibility of the display image with respect to the image data degrades. In the first and second embodiments, in the lower range or in the higher range of the gray scale value D, the reproducibility of a display image can be prevented from degrading by controlling the brightness of a liquid crystal pixel to be the brightness corresponding to the gray scale value D.

What is claimed is:

1. A liquid crystal display device, comprising:
a liquid crystal panel in which a plurality of liquid crystal pixels are arranged;
a gray scale value generation unit which generates, based on a first gray scale value for determining the brightness of a liquid crystal pixel, at least one second gray scale value with a gray scale number smaller than the gray scale number of the first gray scale value; and
a brightness control unit which sequentially controls the brightness of a liquid crystal pixel corresponding to the first gray scale value based on the second gray scale value generated by the gray scale value generation unit in a case where the first gray scale value is larger than a lower threshold value and smaller than an upper threshold value, and which controls the brightness of the liquid crystal pixel corresponding to the first gray scale value based on the first gray scale value in a case where the first gray scale value is not larger than the lower threshold value or is not smaller than the upper threshold value.

2. A liquid crystal display device, comprising:
a liquid crystal panel in which a plurality of liquid crystal pixels are arranged;
a gray scale value generation unit which generates, based on a first gray scale value for determining the brightness of a plurality of liquid crystal pixels, a plurality of second gray scale values with a gray scale number smaller than the gray scale number of the first gray scale value; and
a brightness control unit which sequentially controls the brightness of each of the plurality of liquid crystal pixels corresponding to the first gray scale value based on the plurality of second gray scale values generated by the gray scale value generation unit in a case where the first gray scale value is larger than a lower threshold value and smaller than an upper threshold value, and which controls the brightness of the plurality of liquid crystal pixels corresponding to the first gray scale value based on the first gray scale value in a case where the first gray scale value is not larger than the lower threshold value or is not smaller than the upper threshold value.

3. A liquid crystal driver, comprising:
a gray scale value generation unit which generates, based on a first gray scale value for determining the brightness of a liquid crystal pixel arranged in a liquid crystal panel, at least one second gray scale value with a gray scale number smaller than the gray scale number of the first gray scale value; and
a brightness control unit which sequentially controls the brightness of a liquid crystal pixel corresponding to the first gray scale value based on the second gray scale value generated by the gray scale value generation unit in a case where the first gray scale value is larger than a lower threshold value and smaller than an upper threshold value, and which controls the brightness of the liquid crystal pixel corresponding to the first gray scale value based on the first gray scale value in a case where the first gray scale value is not larger than the lower threshold value or is not smaller than the upper threshold value.

4. A liquid crystal driver, comprising:
a gray scale value generation unit which generates, based on a first gray scale value for determining the brightness of a plurality of liquid crystal pixels arranged in a liquid crystal panel, a plurality of second gray scale values with a gray scale number smaller than the gray scale number of the first gray scale value; and
a brightness control unit which sequentially controls the brightness of each of the plurality of liquid crystal pixels corresponding to the first gray scale value based on the plurality of second gray scale values generated by the gray scale value generation unit in a case where the first gray scale value is larger than a lower threshold value and smaller than an upper threshold value, and which controls the brightness of the plurality of liquid crystal pixels corresponding to the first gray scale value based on the first gray scale value in a case where the first gray scale value is not larger than the lower threshold value or is not smaller than the upper threshold value.

5. The liquid crystal driver according to any one of claims 3 and 4, wherein the brightness control unit controls, based on the first gray scale value or second gray scale value, a voltage of a signal line which determines a voltage applied to a liquid crystal of each of liquid crystal pixels.
